(19) United States
(12) Patent Application Publication
(10) Pub. No.: US 2011/0038165 A1
(43) Pub. Date: Feb. 17, 2011

(54) ILLUMINATION SYSTEM

(75) Inventors: Nien-Hui Hsu, Hsinchu County (TW); Chao-Nan Chien, Hsinchu County (TW); Tsan-Fu Tseng, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: YOUNG GREEN ENERGY CO., HSINCHU COUNTY (TW)

(21) Appl. No.: 12/820,154

(22) Filed: Jun. 22, 2010

(30) Foreign Application Priority Data
Aug. 12, 2009 (CN) 200910162734.9

(51) Int. Cl. F21V 29/00

(52) U.S. Cl. 362/373

(57) ABSTRACT

An illumination system includes a casing having an air inlet and an air outlet, a light source disposed in the casing and capable of generating an illumination beam emitting out of the casing, a fan disposed in the casing and capable of guiding cooling air to the air inlet and the air outlet in sequence, a heat dissipation guiding board disposed in the casing and located at the air inlet for guiding the cooling air from the air inlet to the casing in a direction away from the air outlet, and a power supply disposed on the heat dissipation guiding board. The cooling air flow flowing into the casing and guided by the heat dissipation guiding board flows to the air outlet in a direction away from the air outlet. Thereby, the cooling air flow is allowed to flow in the casing during an increased time within an extended range.

### CROSS-REFERENCE TO RELATED APPLICATION

This application claims the priority benefit of China application serial no. 200910162734.9, filed on Aug. 12, 2009. The entirety of the above-mentioned patent application is hereby incorporated by reference herein and made a part of this specification.

### BACKGROUND OF THE INVENTION

1. Field of the Invention

The invention relates to an illumination system. More particularly, the invention relates to an illumination system having a heat dissipation guiding board.

2. Description of Related Art

Recently, with continuous improvement of luminance and light emitting efficiency of a light emitting diode (LED), the LED acting as a light source is more applicable to an illumination system. Nonetheless, heat is generated during operation of the LED and the heat may result in reduction of light emitting efficiency of the LED. Therefore dissipating the heat generated by the LED to make the LED operate within an appropriate working temperature range is important.

At present, a method of dissipating the heat of an LED lamp includes natural heat convection and forced heat convection. In the natural heat convection, a heat sink occupying a significant area is required, and a casing of the LED lamp with a number of complicated openings may be needed, such that the heat may be transferred to external surroundings through the heat sink. By contrast, in the forced heat convection, transfer of heat to the external surroundings results from a fan blowing hot air to the heat sink. References related to heat dissipation of the lamp by applying the forced heat convection include Taiwan patents Nos. 416531, M298074, M321141, M353313, M341798, and Taiwan patent application publication No. 200819866.

### SUMMARY OF THE INVENTION

The invention is directed to an illumination system having favorable heat dissipation efficiency.

Additional aspects and advantages of the invention may be comprehended to a great extent by referring to descriptions of technical features disclosed in the invention.

In an embodiment of the invention, an illumination system including a casing, a light source, a fan, a heat dissipation guiding board, and a power supply is provided. The casing has an air inlet and an air outlet. The light source is disposed in the casing and capable of generating an illumination beam emitting out of the casing. The fan is disposed in the casing and capable of guiding cooling air flow to the air inlet and the air outlet in sequence. The heat dissipation guiding board is disposed in the casing and located at the air inlet for guiding the cooling air flow from the air inlet to the casing in a direction away from the air outlet. The power supply is disposed on the heat dissipation guiding board.

Based on the above, after the cooling air flow flows into the casing, the cooling air flow is guided by the heat dissipation guiding board and flows from the air inlet in a direction away from the air outlet. Next, the cooling air flow flows to the air outlet according to the embodiment described above. Thereby, the cooling air is allowed to flow in the casing during an increased time within an extended range, so as to improve the heat dissipation efficiency. Besides, dust in the air and rain may be prevented from being blown into the illumination system by strong wind. Namely, the illumination system of the invention is water and dust resistant. Moreover, the cooling air flow contacts the heat dissipation guiding board after flowing into the casing, and the power supply is disposed on the heat dissipation guiding board. Therefore, the cooling air effectively contributes to heat dissipation of the power supply.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is a three dimensional view of an illumination system according to an embodiment of the invention.

FIG. 2 is an exploded view of the illumination system depicted in FIG. 1.

FIG. 3 is a perspective view of some of the components of the illumination system depicted in FIG. 1.

FIG. 4 is a cross-sectional view of some of the components of the illumination system depicted in FIG. 1.

FIG. 5 is an exploded view of an illumination system according to another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

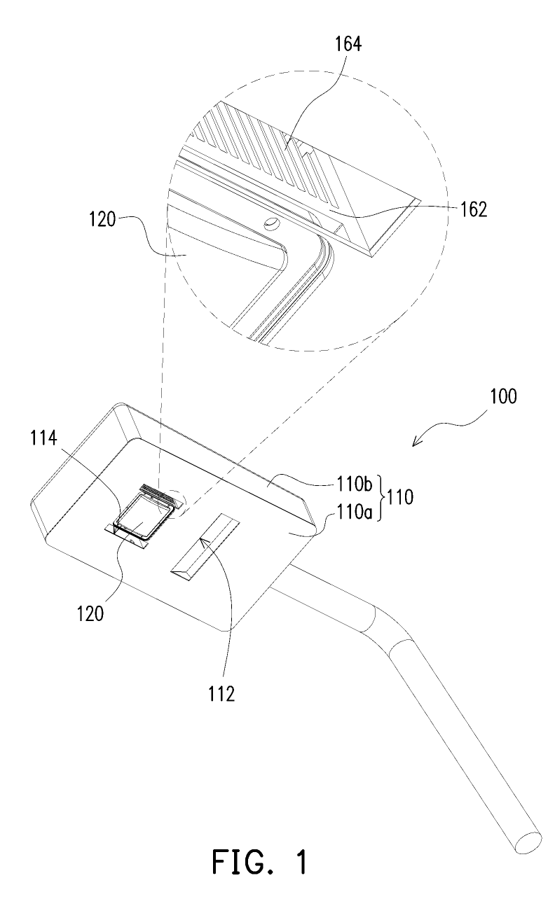

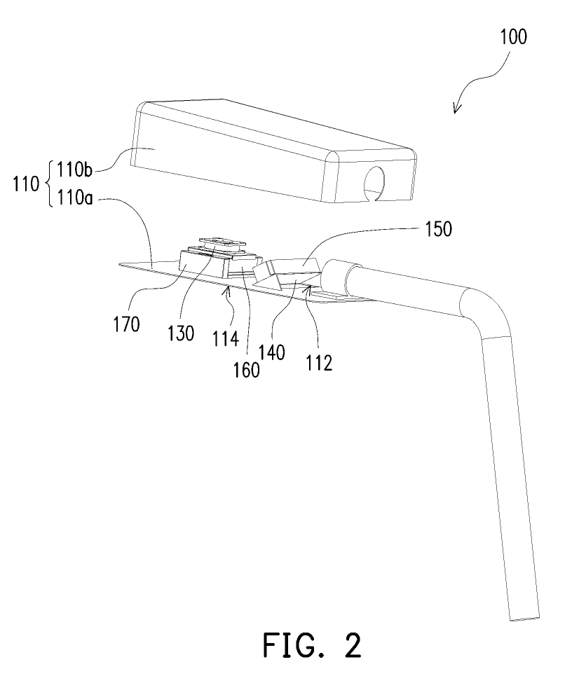

With reference to FIGS. 1 and 2, the illumination system 100 of the embodiment includes a casing 110, a light source 120, a fan 130, a heat dissipation guiding board 140, and a power supply 150. The casing 110 includes a bottom board 110a, an upper cover 110b connecting the bottom board 110a, an air inlet 112, and an air outlet 114. The light source 120 is disposed in the casing 110 and capable of generating an illumination beam emitting out of the casing 110. The fan 130 is disposed in the casing 110 and is capable of guiding cooling air flow to the air inlet 112 and the air outlet 114 in sequence. The power supply 150 is disposed on the heat dissipation guiding board 140 for supplying power to the light source 120.

With reference to FIGS. 1, 2, and 3, the casing 110 includes the bottom board 110a and the upper cover 110b connecting the bottom board 110a, and the heat dissipation guiding board 140 is disposed in the casing 110, located at the air inlet 112, and connected to the bottom board 110a. The heat dissipation guiding board 140 extends from a side 112a of the air inlet 112 in a direction D away from the air outlet 114, and the side of the air inlet 112 is adjacent to the air outlet 114. An included angle C between the bottom board 110a and the heat dissipation guiding board 140 ranges from 30° to 75°, for example, so as to guide cooling air flow A from the air inlet 112 to the casing 110 in the direction D away from the air outlet 114. Besides, the cooling air flow A flows to the air outlet 114 along a path P1 and is then discharged from the casing 110.

Through the heat dissipation guiding board 140, the cooling air flow A is allowed to flow in the casing 110 during an increased time within an extended range, such that the heat in the casing 110 may be dissipated effectively. The cooling air flow A takes the heat of the heat dissipation guiding board 140 away, such that the heat generated by the power supply 150 on the heat dissipation guiding board 140 may be dissipated. Besides, a hydrophilic layer may be disposed on a surface 142 of the heat dissipation guiding board 140 facing the air inlet 112 by coating or electroplating, so as to prevent dust. Thereby, the hydrophilic layer apt to absorb dust may protect the illumination system 100 from being contaminated by dust.

The air outlet 114 is located at an up stream in a flow field. Therefore, the cooling air flow A at the air outlet 114 may perform highly efficient heat conduction with the air at low temperature so as to effectively dissipate heat of the power supply 150. In addition, the heat dissipation guiding board 140 is near the air inlet 112, such that the cooling air flow A passing through the air inlet 112 may contact the heat dissipation guiding board 140 for improving heat dissipation efficiency.

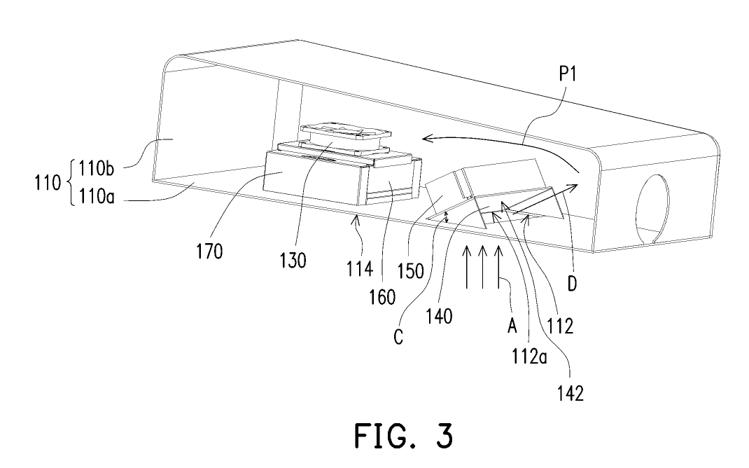

According to the embodiment, a material of the heat dissipation guiding board 140 is, for example, metal, which is conducive to dissipation of heat of the power supply 150. As indicated in FIG. 3, the heat dissipation guiding board 140 extends from the side 112a of the air inlet 112 in the direction D away from the air outlet 114, so as to guide the cooling air flow A to flow along the direction D. Here, the side 112a of the air inlet 112 is adjacent to the air outlet 114. Moreover, an orthographic projection of the air inlet 112 on the casing 110 is located within an orthographic projection of the heat dissipation guiding board 140 on the casing 110. Namely, the heat dissipation guiding board 140 may extend to the extent to sufficiently cover the air inlet 112 and may thereby prevent dust from entering the casing 110 together with the cooling air flow A, thus to avoid affecting the heat dissipation efficiency resulting from the excessive accumulation of dust in the casing 110. Specifically, dust in the external surroundings passes through the air inlet 112 along with the cooling air flow A and is then attached to the heat dissipation guiding board 140. Here, the dust attached to the heat dissipation guiding board 140 spontaneously falls because of gravity, such that heat dissipation efficiency is not affected by excessive dust.

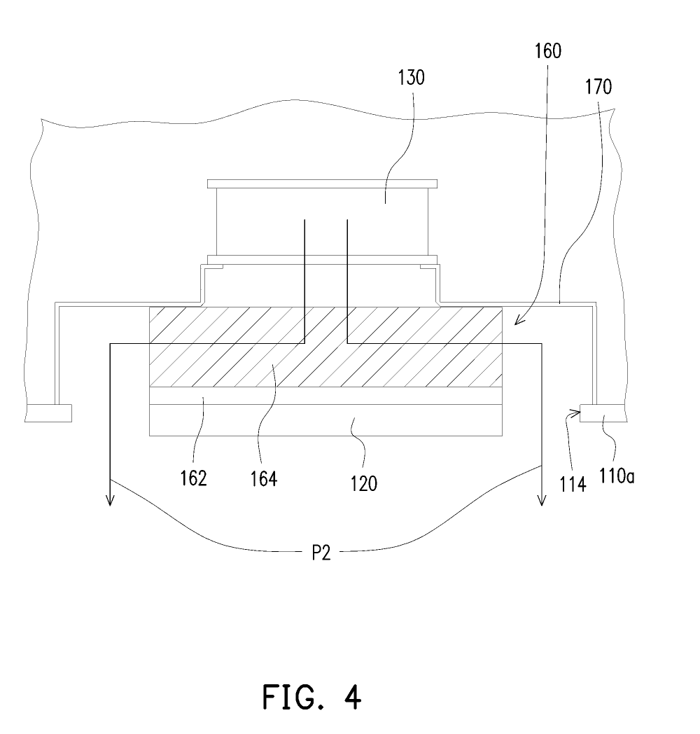

With reference to FIGS. 2-4, the illumination system 100 of the embodiment further includes a heat sink 160. The heat sink 160 is connected to the light source 120 and located in the casing 110 to dissipate heat generated by the light source 120. In particular, as shown in FIG. 1, the heat sink 160 includes a heat dissipation bottom board 162 connected to the light source 120 and a plurality of heat dissipation fins 164 connected to the heat dissipation bottom board 162, so as to expand available area for heat dissipation.

With reference to FIGS. 2-4, the illumination system 100 of the embodiment further includes an air-guiding casing 170. The air-guiding casing 170 is disposed on the heat sink 160. The fan 130 is disposed on the air-guiding casing 170 for guiding the cooling air A to be discharged from the air outlet 114 through the heat sink 160. In other embodiments, the fan 130 may also be disposed on the heat sink 160.

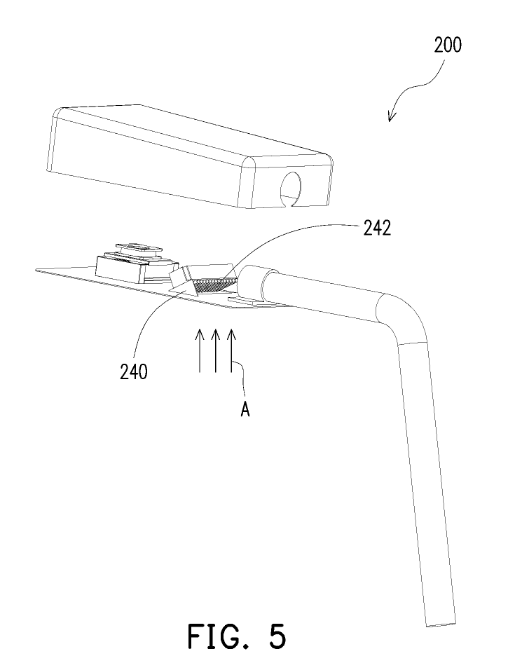

With reference to FIG. 5, in comparison with the illumination system 100 depicted in FIGS. 1-4, the illumination system 200 of the embodiment has a heat dissipation guiding board 240 equipped with a plurality of heat dissipation fins 242, such that heat dissipation efficiency may be improved when the cooling air flow A passes through the heat dissipation guiding board 240.

According to the embodiments, the heat dissipation guiding board is near the air inlet, and an included angle is formed between the heat dissipation guiding board and the bottom board. Moreover, the heat dissipation guiding board extends in the direction away from the air outlet. After the cooling air flow flows into the casing, the cooling air flow is guided by the heat dissipation guiding board and flows from the air inlet in a direction away from the air outlet. Next, the cooling air flow flows to the air outlet. Thereby, the cooling air flow is allowed to flow in the casing during an increased time within an extended range, so as to improve the heat dissipation efficiency. Besides, dust in the air and rain may be prevented from being blown into the illumination system by strong wind. Namely, the illumination system of the invention is water and dust resistant. Moreover, the cooling air contacts the heat dissipation guiding board after the cooling air flow flows into the casing, and the power supply is disposed on the heat dissipation guiding board. Therefore, the cooling air flow contributes to effective heat dissipation of the power supply.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising:
a casing having an air inlet and an air outlet;
a light source disposed in the casing and capable of generating an illumination beam emitting out of the casing;
a fan disposed in the casing and capable of guiding a cooling air flow to the air inlet and the air outlet in sequence;
a heat dissipation guiding board disposed in the casing and located at the air inlet capable of guiding the cooling air flow from the air inlet to the casing in a direction away from the air outlet; and
a power supply disposed on the heat dissipation guiding board.

2. The illumination system as claimed in claim 1, wherein a material of the heat dissipation guiding board comprises metal.

3. The illumination system as claimed in claim 1, wherein the heat dissipation guiding board has a plurality of heat dissipation fins capable of allowing the cooling air flow to pass through.

4. The illumination system as claimed in claim 1, wherein the heat dissipation guiding board extends from a side of the air inlet to the casing in the direction away from the air outlet, and the side of the air inlet is adjacent to the air outlet.

5. The illumination system as claimed in claim 1, wherein an orthographic projection of the air inlet on the casing is located within an orthographic projection of the heat dissipation guiding board on the casing.

6. The illumination system as claimed in claim 1, wherein a hydrophilic layer is formed on a surface of the heat dissipation guiding board facing the air inlet.

7. The illumination system as claimed in claim 1, wherein the casing comprises a bottom board and an upper cover connected to the bottom board, the heat dissipation guiding board is connected to the bottom board, and an included angle between the bottom board and the heat dissipation guiding board ranges from 30° to 75°.

8. The illumination system as claimed in claim 1, further comprising:
a heat sink connected to the light source and located in the casing.

9. The illumination system as claimed in claim 8, wherein the fan is disposed on the heat sink.

10. The illumination system as claimed in claim 9, further comprising:
an air-guiding casing disposed on the heat sink, wherein the fan is disposed on the air-guiding casing or on the heat sink capable of guiding the cooling air flow to be discharged from the air outlet through the heat sink.

11. The illumination system as claimed in claim 8, wherein the heat sink comprises a heat dissipation bottom board connecting the light source and a plurality of heat dissipation fins connecting the heat dissipation bottom board.
